(19) United States
(12) Patent Application Publication
(10) Pub. No.: US 2025/0030306 A1
(43) Pub. Date: Jan. 23, 2025

(54) ROTOR SHAFT AND ELECTRICAL MACHINE

(71) Applicant: MAHLE International GmbH, Stuttgart (DE)

(72) Inventor: Christoph Steinmetz, Ludwigsburg (DE)

(21) Appl. No.: 18/776,240

(22) Filed: Jul. 17, 2024

(30) Foreign Application Priority Data
Jul. 19, 2023 (DE) 10 2023 206 835.4

(51) Int. Cl. H02K 7/00; H01F 38/18; H02K 5/15; H02K 7/08; H02K 11/00

(52) U.S. Cl. CPC H02K 7/003; H01F 38/18; H02K 5/15; H02K 7/083; H02K 11/0094

(57) ABSTRACT

A rotor shaft for a rotor of an electric machine may include a hollow shaft, an extension element, a first bearing device, and a second bearing device. The hollow shaft may extend along an axial direction from a first axial end section to a second axial end section. The extension element may be adapted separately from the hollow shaft and may be connected to the first end section of the hollow shaft via a first bearing device such that the extension element is rotatable in relation to the hollow shaft. The extension element may extend beyond the first end section as an axial extension of the hollow shaft. The second bearing device may be arranged on an outside of the second end section of the hollow shaft and may be connected to the hollow shaft to form at least one of a rotatable connection and a rotationally fixed connection.

### CROSS-REFERENCE TO RELATED APPLICATION

This application claims priority to German Patent Application No. DE 10 2023 206 835.4, filed on Jul. 19, 2023, the contents of which is hereby incorporated by reference in its entirety.

### TECHNICAL FIELD

The invention relates to a rotor shaft for a rotor of an electric machine and an electric machine with such a rotor shaft.

### BACKGROUND

Conventional rotor shafts for electric machines are frequently adapted in the form of a sequence of multiple cylinders with different diameters and respectively different functional elements to form bearing points, to form a joining seat for rotor plates and balancing disks, to accommodate cable guides in case the electric machine is an externally excited synchronous machine, and the like.

This geometric sequencing of the individual functional elements leads to a comparatively large installation space requirement with regard to the axial longitudinal extension of the rotor shaft.

Conventional rotor shafts are often adapted as hollow shafts and have two bearing devices arranged axially at a distance from one another such that the rotor shaft can rotate.

For the sake of simplicity, both bearing devices are often adapted identically or are at least dimensioned identically, even if an individualized adaptation of the two bearing devices could be expedient due to the different loads on the two bearing devices.

### SUMMARY

Against this background, it is an object of the present invention to demonstrate new development approaches of rotor shafts for electric machines or their rotors. In particular, an improved embodiment is to be created for a rotor shaft, characterized by a reduced installation space requirement compared to conventional rotor shafts, while at the same time keeping the engineering design simple and thus reducing manufacturing costs.

This object is achieved by the scope of the independent claim(s). Preferred embodiments are the scope of the dependent claim(s).

The basic idea of the invention is therefore to not have two identical bearing devices for rotatably mounting a rotor shaft, but to connect one of the two bearing devices to the hollow shaft using an extension element adapted separately from the actual hollow shaft. Said extension element is thus adapted to be rotatable relative to the actual hollow shaft with the aid of these bearing devices such that the extension element can form a locally fixed connection, for example to a stator or to a housing of the electric machine.

Using said extension element, the hollow shaft can form a mechanically rigid and stable connection to a locally fixed component of an electric machine, such as said stator or housing of the electric machine, while also being able to rotate. This is accompanied by an advantageous reduction of an undesirable bending of the hollow shaft during operation of the rotor shaft. This in turn advantageously reduces the mechanical load that occurs on both the unloaded side and on the loaded side, i.e., a load transferring side, and thus in both bearing devices of the rotor shaft. In principle, this is accompanied by the advantageous ability of dimensioning the bearing device connected to the extension element smaller than the other one of the two bearing devices. Lastly, the extension element can be produced independently of the rotor shaft and can thus be produced more cost-effectively than a conventional rotor shaft with a conventional bearing pin.

Following the basic idea of the invention, an inventive rotor shaft for a rotor of an electric machine comprises a hollow shaft extending along an axial direction from a first axial end section to a second axial end section. The rotor shaft further comprises an extension element preferably adapted as a sleeve and necessarily separate from the hollow shaft. The rotor shaft comprising the hollow shaft and the extension element is therefore formed at least in two parts. The extension element is rotatably connected by means of a first bearing device to the first end section of the hollow shaft and extends axially beyond the first end section of the hollow shaft to axially extend the latter. The rotor shaft further comprises a second bearing device arranged on the second end section of the hollow shaft that forms a rotatable or rotationally fixed connection to the latter.

According to an advantageous further embodiment, a radially inwardly projecting bearing plate can be formed or arranged, in particular integrally, on the hollow shaft axially in the region of the first end section, against which, or to which, the first bearing device is supported and/or fastened, respectively.

According to a further advantageous further embodiment, an electrical line or cable gland is provided axially in the region of the first end section on hollow shaft and on the extension element, in particular for providing an electrical connection from the locally fixed extension element to the rotating hollow shaft, and thus for transmitting electrical energy from the extension element to the hollow shaft. The adaptation of the inventive rotor shaft with a locally fixed extension element simplifies the construction of such a line or cable gland, the routing of electrical lines or cables on the rotatable hollow shaft including its fluidic seal since the seal can be formed on the stationary extension element.

Said electrical line or cable gland can in particular be used to supply electrical energy to electrically energized rotor coils arranged on the rotor for generating a magnetic rotor field when the inventive rotor shaft is used as part of a rotor in an electric machine. The electrical line or cable gland is thus used to transmit electrical energy from the locally fixed stator system to the rotor system rotating while the electric machine is in operation. The installation space provided in the first end section or in the region of the extension element can be effectively used to supply electrical energy or power to the components arranged on the rotor shaft, in particular the aforementioned rotor coils of a rotor.

Particularly preferably, the electrical line or cable gland can be adapted as an electrical rotary transformer to transmit electrical energy wirelessly. Such a rotary transformer transmits energy inductively and thus wirelessly from the locally fixed extension element to the rotatable or rotating hollow shaft. Due to the wireless electrical connection between the locally fixed extension element and the rotating hollow shaft, an electric rotary transformer avoids undesirable wear effects that occur in a wire-based electrical connection, such as in a wire-based sliding contact due to the resulting sliding friction.

In another preferred embodiment, the rotary transformer comprises a rotary transformer rotor connected stationary to the hollow shaft and a rotary transformer stator arranged axially at a distance from the rotary transformer rotor and inductively coupled thereto, wherein said rotary transformer stator forms a fixed or rotationally fixed connection to the extension element. Such a rotary transformer stator and such a rotary transformer rotor can both have at least one electrically energized rotary transformer stator coil or rotary transformer rotor coil that generate a magnetic field when electrically energized. The rotary transformer stator coil and the rotary transformer rotor coil must be magnetically coupled to one another such that when the transformer stator coil is electrically energized—following the law of induction—an electrical alternating voltage and thus an electric alternating current is induced due to the existing magnetic coupling to the rotary transformer coil. After rectification of this alternating electric current, it can be used to energize the rotor of the electric machine. The rotor can thus be driven by magnetic interaction with the stator of the electric machine. This functional principle is particularly applied in an externally excited electrical synchronous machine such that the use of the rotary transformer explained above proves to be particularly advantageous in an externally excited electrical synchronous machine.

In a particularly preferred embodiment, the rotary transformer can be arranged axially on a side of the first bearing device and/or of the bearing plate facing away from the interior, i.e., outside of the interior space. This variant enables the worker to have particularly good access to the rotary transformer such that it can be mounted, but also removed again, particularly easily.

In an alternative, but also particularly preferred, embodiment compared to the embodiment explained above, the rotary transformer can be arranged axially on a side of the first bearing device and/or of the bearing plate facing the interior space, i.e., in the interior space surrounded by the hollow shaft. The rotary transformer can particularly preferably be arranged, most preferably completely, in the interior chamber. This variant requires particularly little installation space because the interior space present in the hollow shaft can be used to accommodate the rotary transformer. As a result, no further installation space outside the hollow shaft is required to accommodate the rotary transformer. Consequently, the entire rotor shaft with the rotary transformer also requires very little installation space.

In another preferred further embodiment of the inventive rotor shaft, the electrical line or cable gland is adapted for wire-based electrical energy transfer and can for this purpose have at least one slip ring as part of a sliding contact that preferably forms a rotationally fixed connection to the extension element or to the hollow shaft.

In another preferred embodiment of the inventive rotor shaft, the first bearing device is supported radially against the outside of the hollow shaft and radially against the inside of the extension element, in particular against a circumferential wall of the extension element. As a result, the hollow shaft can be mechanically stiffened by the first bearing device and can also be rotatably mounted in a particularly stable manner.

According to a further advantageous further embodiment of the inventive rotor shaft, a coupling device for drive coupling the rotor shaft can be formed with an external component in the second end section of the hollow shaft. In this case, the coupling device forms an output element for transferring the rotational movement of the rotor shaft to the external component by means of said drive connection. Said coupling device or said drive element can in particular be formed by a surface structure provided on the outer circumference or inner circumference of the rotor shaft.

A diameter of the hollow shaft measured in radial direction can expediently be reduced in the second end section. The hollow shaft therefore has a diameter in its second end section that is smaller than in at least one axial section different from the second end section. This axial section can in particular comprise the first end section. Said axial section can be complementary to the second end section.

In another preferred embodiment, an extension of the second end section of the hollow shaft measured along the axial direction can be greater than a projection of the extension element measured along the axial direction beyond the first end section of the hollow shaft. The rotor shaft is thus axially particularly compact in the region of the first axial end section. This embodiment proves to be advantageous, in particular in combination with a coupling device for drive coupling the rotor shaft with an external component provided in the second end section (as already explained above), if said external component is arranged outside, preferably on the outer circumference, of the second end section.

In another preferred embodiment, the first bearing device is arranged radially between the hollow shaft and the extension element. As a result, the installation space of the rotor shaft required in radial direction can be kept small. In both variants explained above, the entire rotor shaft requires particularly little installation space in axial direction compared to conventional rotor shafts with two bearings.

In another preferred embodiment, the first bearing device is arranged axially in the region of the first end section in an interior space at least radially delimited by the hollow shaft. This variant also reduces the installation space required by the rotor shaft in radial direction.

The first and/or second bearing device can particularly expediently be adapted as a radial bearing.

In a preferred embodiment, the first bearing device also forms a rotationally fixed connection to the extension element and is rotatably connected in relation to the hollow shaft. In an alternative variant, the first bearing device can form a rotationally fixed connection to the hollow shaft and can also be rotatably connected to the extension element. The person skilled in the art can thus select and implement the most advantageous variant specific to the application.

In another preferred embodiment, the second bearing device has a greater spatial extension than the first bearing device. Alternatively or additionally, in this variant, the second bearing device is adapted to absorb larger bearing forces than the first bearing device.

The invention further relates to an electric machine. The inventive electric machine comprises a housing that, in particular at least radially, encloses a housing interior space [sic]. Furthermore, the machine comprises a stator arranged to form a locally fixed connection to the housing in the housing interior and also a rotor that is at least partially arranged in the housing interior and can be rotated in relation to the stator and magnetically coupled thereto, and can in particular be driven by said stator by means of magnetic interaction. According to the invention, the rotor comprises an inventive rotor shaft presented above, on which magnetic field generation elements are arranged to form a rotationally fixed connection for generating a magnetic field. Advantages of the inventive rotor shaft explained above are therefore transferred to the inventive electric machine. Said magnetic field generation elements can in particular be formed by electrically energized rotor coils or by permanent magnets. In the inventive machine, the extension element of the rotor shaft forms a fixed, in particular rigid, connection to the housing and/or to the stator. In addition, the hollow shaft is rotatably mounted on the housing and/or on the stator by means of the second bearing device.

Further important features and advantages of the invention are apparent from the sub-claims, from the drawings and from the associated description of the figures with reference to the drawings.

It is understood that the above-mentioned features and those yet to be explained below can be used not only in the combination indicated in each case, but also in other combinations or on their own, without deviating from the scope of the present invention.

Preferred exemplary embodiments of the invention are shown in the drawings by way of example and will be explained in more detail in the following description, wherein identical reference signs refer to identical or similar or functionally identical elements.

### BRIEF DESCRIPTION OF THE DRAWINGS

These show—schematically in each case—in

FIG. 1 shows a first example of an inventive rotor shaft,

FIG. 2 shows a first further embodiment of the rotor shaft from FIG. 1 in the region of the extension element with an electrical line or cable gland for wire-based energy transfer from the locally fixed extension element to the rotor shaft.

FIGS. 3 and 4 show a second or third further embodiment of the rotor shaft from FIG. 1 in the region of the extension element with an electrical line or cable gland for wireless energy transfer from the locally fixed extension element to the rotor shaft.

### DETAILED DESCRIPTION

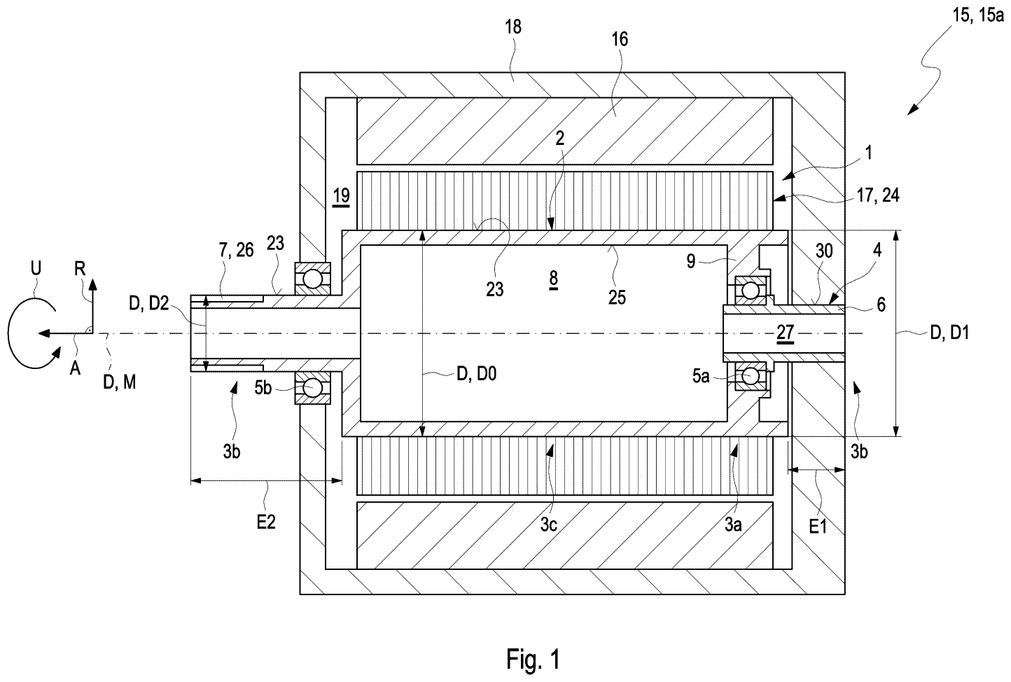

FIG. 1 shows a rough schematic sectional view of an example of an inventive electric machine 15 with an inventive rotor shaft 1 that is shown greatly enlarged in FIG. 1 to illustrate the circumstances.

According to FIG. 1, the inventive electric machine 15 comprises a housing 18 (shown in a highly simplified manner) that encloses a housing interior 19. In the housing interior 19, a stator 16 is arranged to form a locally fixed connection to the housing 18, which can be fastened to the housing 18 and is only shown in a rough schematic form in FIG. 1.

The electric machine 15 further comprises a rotor 17 that is arranged in the housing interior 19 and is adapted to rotate relative to the stator 16 about a predetermined axis of rotation D and comprises an inventive rotor shaft 1. The stator 16 and the rotor 17 can each comprise electrically energized stator or rotor coils (not shown) that generate a magnetic field when electrically energized.

The rotor shaft 1 comprises a hollow shaft 2, on the outer circumference 23 of which rotor coils 24 can be arranged to form a rotationally fixed connection to the hollow shaft 2 or to the rotor shaft 1 as part of the rotor 17 (only indicated in FIG. 1 in a rough schematic manner), by means of which a magnetic rotor field can be generated. The use of rotor coil 24 is in particular advantageous if the electric machine 15 is an externally excited electric synchronous machine 15a. Due to the magnetic interaction of the magnetic stator field with the magnetic rotor, the rotor 17, including the rotor shaft 1, can be driven and thus displaced with respect to the stator 16 or the housing in a rotational movement about the axis of rotation D. Permanent magnets (not shown) can also be used instead of rotor coils 24.

As can be seen in FIG. 1, the rotor shaft 1 is formed in multiple parts and comprises at least one hollow shaft 2 as well as an extension element 4 that is formed separately from the hollow shaft 2, both of which extend along an axial direction A and can both be arranged coaxially in relation to one another as shown. The hollow shaft 2 delimits an interior space 8 of the rotor shaft 1.

In the example scenario, a common central longitudinal axis M of the hollow shaft 2 and the extension element 4 form an axis of rotation D of the rotor shaft 1. A radial direction R extends vertically in relation to the axial direction A away from the central longitudinal axis M and/or the rotational axis D. A circumferential direction U extends about the central longitudinal axis M and/or about the rotational axis D vertically in relation to the axial direction A and also in relation to the radial direction R.

As FIG. 1 further shows, the extension element 4 of the rotor shaft 1 forms a rigid and thus fixed connection to the housing 18 and is thus—indirectly by the housing 18—also permanently connected to the stator 16 of the electric machine 15. In a not shown variant, a direct fixed or rigid connection of the extension element 4 to the stator 16 is also conceivable. Both connection variants can, for example, be realized by means of a clamped connection (not shown).

The hollow shaft 2 extends along the axial direction A from a first axial end section 3a to a second axial end section 3b. According to FIG. 1, the extension element 4 can be adapted as a sleeve and, similar to the hollow shaft 2, can also surround an element interior space 27 that can fluidically communicate to the interior chamber 8. The extension element 4 is rotatably connected to the first end section 3a of the hollow shaft 2 by means of a first bearing device 5a and extends in relation to the axial extension of the hollow shaft 2 beyond the first end section 3a of the latter such that the extension element 4 axially extends the hollow shaft 2. As shown, the first bearing device 5a can be arranged axially in the region of the first end section 3a in the interior space 8 delimited by the hollow shaft 2. In addition, the first bearing device 5a is arranged as shown radially between the hollow shaft 2 and the extension element 4. The first bearing device 5a is supported radially on the outside on an inner circumferential side 25 of the hollow shaft 2 and radially on an outer circumferential side 30 of a circumferential wall 6 of the extension element 4.

The rotor shaft 1 further comprises a second bearing device 5b arranged on the outer circumference 23 of the second end section 3b of the hollow shaft 2 and is rotatably connected to the latter. The hollow shaft 2 is rotatably mounted on the housing 18 by means of the second bearing device 5b, for which the second bearing device 5b can be permanently connected to the housing 18.

The two bearing devices 5a, 5b can each be adapted as radial bearings. The second bearing device 5b can have a larger spatial extension or spatial expansion than the first bearing device 5a (not shown) and can also be adapted to absorb larger bearing forces than the first bearing device 5a.

Furthermore, a coupling device 7 for drive coupling the rotor shaft 1 can be formed with an external component in the second end section 3b of the hollow shaft 2. In the example from FIG. 1, the coupling device 7 is formed by a tooth structure 26 extending along the circumferential direction U on the outer circumference 23 of the hollow shaft 2 or by another suitable surface structure. The coupling device 7 forms an output element for transferring the rotational movement of the rotor shaft 1 to said external component using said drive connection.

As shown in FIG. 1, a diameter D of the hollow shaft 2 measured along the radial direction R can be expediently reduced in its second end section 3b. A value D2 of the diameter D of the hollow shaft 2 in its second end section 3b is therefore less than a value D1 of the diameter D in the region of the first end section D1 and also less than a value D0 of the diameter D of the hollow shaft 2 in an axial region 3c between the two axial end sections 3a, 3b.

Furthermore, as shown in the example, an extension E2 of the second end section 3b of the hollow shaft 2 measured along the axial direction A can be greater than a projection E1 of the extension element 4 measured along the axial direction A beyond the first end section 3a of the hollow shaft 2.

In the region of the first end section 3a, an annular bearing plate 9 that projects inward along the radial direction R into the interior space 8 and against which the first bearing device 5a is supported and to which the latter can also be fastened, can be integrally formed on the hollow shaft 2.

In the example scenario of FIG. 1, the first bearing device 5a forms a rotationally fixed connection to the extension element 4 and is rotatably connected to the hollow shaft 2. In an alternative variant, however, the first bearing device 5a can also form a rotationally fixed connection to the hollow shaft 2 and can correspondingly be rotatably connected to the extension element 4.

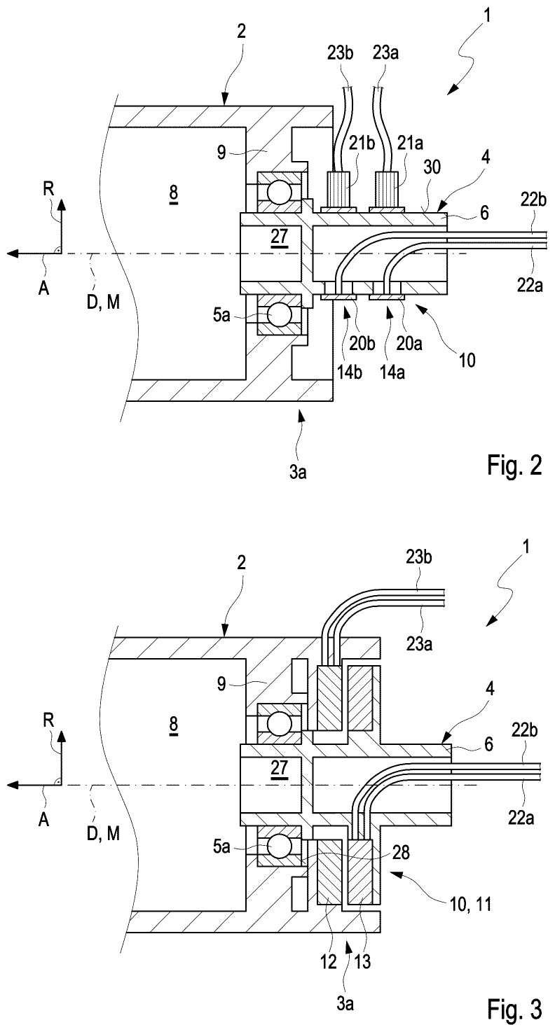

FIG. 2 shows a first further embodiment of the rotor shaft from FIG. 1. In this further embodiment, an electrical line or cable gland 10 for transmitting electrical energy from the extension element 4 to the rotor shaft 2 rotatable in relation to the extension element 4 is formed in the region of the first end section 3a on the hollow shaft 2 and also on the extension element 4. In the example scenario, the electrical line or cable gland 10 is adapted to supply electrical energy to electrically energized rotor coils 24 for generating a magnetic rotor field and arranged on the rotor 17 (not shown in FIG. 2, cf. FIG. 1). Using the electrical line or cable gland 10, electrical energy is thus transmitted from the locally fixed stator system to the rotor system that rotates while the electric machine 15 (cf. FIG. 1) is in operation.

In the example from FIG. 2, the line or cable gland 10 is adapted for wire-based electrical energy transmission. For this purpose, the line or cable gland 10 comprises two sliding contacts 14a, 14b arranged axially at a distance from one another. Each of the two sliding contacts 14a, 14b comprises an electrically conductive slip ring 20a or 20b arranged on the circumferential side 30 of the extension element 4 and extending along the circumferential direction U. Each of the two sliding contacts 14a, 14b also comprises an electrically conductive brush 21a or 21b that cooperates with the respective slip ring 20a or 20b and rotates with the hollow shaft 2 and which therefore rests against the respective slip ring 20a, 20b to form an electrically conductive connection during the rotary movement of the hollow shaft 2. By means of the two sliding contacts 14a, 14b, electrical lines 22a, 22b arranged locally fixed to the electrical connection element 4 can be electrically connected to electrical lines 23a or 23b, which rotate with the hollow shaft 2.

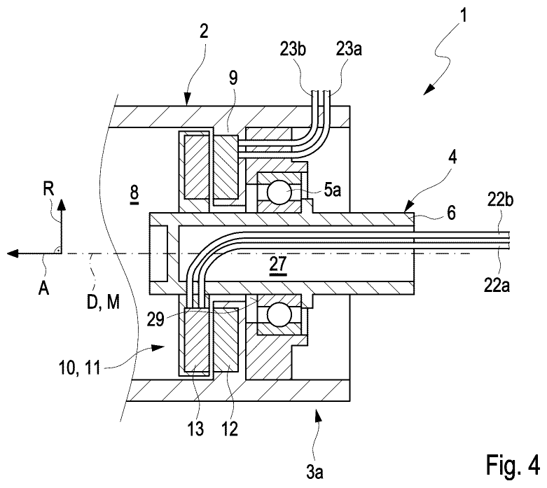

FIG. 3 shows a second further embodiment of the rotor shaft 1 from FIG. 1 as an alternative to the first further embodiment. According to this third further embodiment, the electrical line or cable gland 10 can be adapted as an inductive rotary transformer 11 of the electric machine 15 for wireless electrical energy transfer, which electrical line or cable gland 10 comprises a rotary transformer rotor 12 forming a rotationally fixed connection to the rotatable hollow shaft 2 and a rotary transformer stator 13 forming a rotationally fixed connection to the extension element 4 and inductively coupled to the rotary transformer rotor 12 such that the rotary transformer rotor 12 can be rotated in relation to the rotary transformer stator 13. In such a rotary transformer 11, the energy is transferred inductively from the rotary transformer stator 13 to the rotary transformer rotor 12. The alternating magnetic field generated by the rotary transformer stator 13 by corresponding electrical energization of its rotary transformer stator coil (not shown) induces an electrical alternating current by axial magnetic coupling in a rotary transformer rotor coil (not shown) of the rotary transformer rotor 12, with which the rotor coils 24 (see FIG. 1) of the electric machine 15 can be electrically energized. As shown in FIG. 3, the rotary transformer 11 can expediently be arranged axially on a side 28 of the bearing plate 9 facing away from the interior space 8, and thus also of the first bearing device 5a, i.e., outside of the interior chamber 8.

FIG. 4 illustrates a third further embodiment of the example from FIG. 1. The third further embodiment is an alternative variant of the second further embodiment from FIG. 3 and differs—as can be seen from FIGS. 3 and 4—from the second further embodiment in that the rotary transformer 11 is arranged axially on a side 29 of the first bearing device 5a facing the interior space 8, and thus also of the bearing plate 9. The rotary transformer 11 is therefore arranged in the interior space 8.

In the examples from FIGS. 3 and 4, electrical energy is transferred from the two electrical lines 22a, 22b to the two electrical lines 23a or 23b, and thus wirelessly.

1. A rotor shaft for a rotor of an electric machine, comprising:
a hollow shaft extending along an axial direction from a first axial end section to a second axial end section;
an extension element adapted separately from the hollow shaft and connected to the first end section of the hollow shaft via a first bearing device such that the extension element is rotatable in relation to the hollow shaft, the extension element extending beyond the first end section as an axial extension of the hollow shaft; and
a second bearing device arranged on an outside of the second end section of the hollow shaft and connected to the hollow shaft to form at least one of a rotatable connection and a rotationally fixed connection.

2. The rotor shaft according to claim 1, further comprising a radially inwardly projecting bearing plate arranged on the hollow shaft axially in a region of the first end section, and wherein the first bearing device is supported against the bearing plate.

3. The rotor shaft according to claim 1, further comprising at least one of an electrical line and a cable gland disposed in a region of the first end section on the hollow shaft and on the extension element.

4. The rotor shaft according to claim 3, wherein the at least one of the electrical line and the cable gland at least one of is adapted as, is a part of, and includes a rotary transformer for wireless electrical energy transfer.

5. The rotor shaft according to claim 4, wherein:
the rotary transformer includes:
a rotary transformer rotor connected to form a rotationally fixed connection to the hollow shaft; and
a rotary transformer stator arranged axially at a distance from the rotary transformer rotor and inductively coupled, to the rotary transformer rotor; and
the rotary transformer stator forms a fixed connection to the extension element.

6. The rotor shaft according to claim 5, wherein the rotary transformer is arranged axially on a side of the first bearing device facing away from an interior chamber of the hollow shaft.

7. The rotor shaft according to claim 5, wherein the rotary transformer is arranged axially on a side of the first bearing device facing an interior chamber of the hollow shaft.

8. The rotor shaft according to claim 5, wherein the rotary transformer is arranged in an interior chamber delimited by the hollow shaft.

9. The rotor shaft according to claim 3, wherein the at least one of the electrical line and the cable gland is adapted for wire-based electrical energy transfer and includes at least one slip ring as part of a sliding contact that forms a connection to at least one of the extension element and the hollow shaft.

10. The rotor shaft according to claim 1, wherein the first bearing device is supported radially against an outside of the hollow shaft and radially against an inside of the extension element.

11. The rotor shaft according to claim 1, further comprising a coupling device for drive coupling the rotor shaft, wherein the coupling device includes an external component disposed in the second end section of the hollow shaft.

12. The rotor shaft according to claim 1, wherein a diameter of the hollow shaft is reduced in the second end section relative to the diameter of the hollow shaft in at least one other section of the hollow shaft.

13. The rotor shaft according to claim 1, wherein an extension of the second end section of the hollow shaft measured along the axial direction is greater than a projection of the extension element measured along the axial direction beyond the first end section of the hollow shaft.

14. The rotor shaft according to claim 1, wherein the first bearing device is arranged radially between the hollow shaft and the extension element.

15. The rotor shaft according to claim 1, wherein the first bearing device is arranged axially in a region of the first end section of the hollow shaft in an interior chamber delimited by the hollow shaft.

16. The rotor shaft according to claim 1, wherein one of:
the first bearing device forms a rotationally fixed connection to the extension element and is rotatably connected in relation to the hollow shaft; and
the first bearing device forms a rotationally fixed connection to the hollow shaft and is rotatably connected in relation to the extension element.

17. The rotor shaft according to claim 1, wherein at least one of:
the second bearing device has a larger spatial extent than the first bearing device; and
the second bearing device is adapted to absorb larger bearing forces than the first bearing device.

18. An electrical machine, comprising:
the rotor shaft according to claim 1;
a housing enclosing a housing interior;
a stator arranged in the housing interior and locally fixed in relation to the housing;
a rotor at least partially arranged in the housing interior, the rotor rotatable in relation to the stator, magnetically coupled to the stator, and driven by the stator;
wherein the rotor includes the rotor shaft and a plurality of magnetic field generating elements are arranged on the rotor shaft to form a rotationally fixed connection for generating a magnetic rotor field;
wherein the extension element of the rotor shaft forms a fixed connection to at least one of the housing and the stator; and
the hollow shaft is mounted rotatably on at least one of the housing and the stator via the second bearing device.

19. The rotor shaft according to claim 1, wherein the extension element is a sleeve.

20. The rotor shaft according to claim 5, further comprising a radially inwardly projecting bearing plate arranged on the hollow shaft axially in the region of the first end section, wherein:
the hollow shaft delimits an interior chamber;
the first bearing device is supported against the bearing plate; and
the rotary transformer is arranged axially on a side of the first bearing device and a side of the bearing plate facing one of (i) toward the interior chamber and (ii) away from the interior chamber.
